(19) United States
(12) Patent Application Publication
(10) Pub. No.: US 2013/0016052 A1
(43) Pub. Date: Jan. 17, 2013

(54) TOUCH PANEL AND TOUCH-SENSING DISPLAY APPARATUS

(71) Applicants: Chih-Hsien Lien, Taichung City (TW); Su-Ming Lin, Taichung City (TW); Peng-Chih Yu, Penghu County (TW); Ping-Wen Huang, Taichung City (TW)

(72) Inventors: Chih-Hsien Lien, Taichung City (TW); Su-Ming Lin, Taichung City (TW); Peng-Chih Yu, Penghu County (TW); Ping-Wen Huang, Taichung City (TW)

(73) Assignees: WINTEK CORPORATION, Taichung City (TW); WINTEK (CHINA) TECHNOLOGY LTD., Guangdong Province (CN)

(21) Appl. No.: 13/541,646

(22) Filed: Jul. 3, 2012

(30) Foreign Application Priority Data
Jul. 12, 2011 (TW) 100124639

(51) Int. Cl. G06F 3/041

(52) U.S. Cl. 345/173

(57) ABSTRACT

A touch panel having a display region and a non-display region surrounding the display region is provided. The touch panel includes a substrate, a first touch sensing element, a decoration layer, a decoration pattern, and a plurality of transmission lines. The first touch sensing element is located at least in the display region. The decoration layer is located in the non-display region of the substrate. The decoration layer has a slot. The decoration pattern is disposed on the substrate corresponding to the slot. The transmission lines disposed in the non-display region cross over the slot, wherein each transmission line includes a transparent section and a plurality of non-transparent sections connected with two opposite sides of the transparent section and the transparent section is at a location at least corresponding to the slot.

### CROSS-REFERENCE TO RELATED APPLICATION

This application claims the priority benefit of Taiwan application serial no. 100124639, filed on Jul. 12, 2011. The entirety of the above-mentioned patent application is hereby incorporated by reference herein and made a part of this specification.

### BACKGROUND

1. Field of the Invention

The present invention relates to a touch panel, and more particularly to a touch panel with a non-display region, wherein the design of the non-display region is flexible.

2. Description of Related Art

A touch-sensing display apparatus is constructed with a display panel and a touch panel. In order for the touch panel to transmit signals, a plurality of transmission lines is arranged in the non-display region of the touch panel. To conceal the transmission lines and to provide the touch-sensing apparatus with a frame, a decoration film is disposed in the touch-sensing display apparatus at a location corresponding to the non-display region.

Generally speaking, the touch panel is the outermost component of an electronic product. Restricted by the frame design of the touch panel, an electronic product is normally provided with a frame of a single color. However, a mono-color frame is unable to attune to the increasing demand of the current users on product appearance. Accordingly, to improve the appearance of a product, the design of a touch panel is an important research focus.

### SUMMARY OF THE DISCLOSURE

An exemplary embodiment of the invention provides a touch panel, wherein in addition to appearing in a single color, the frame of the touch panel may also appear in other color patterns.

An exemplary embodiment of the invention provides a touch panel that includes a display region and a non-display region surrounding the display region. The touch panel includes a substrate, a first touch sensing element, a second touch sensing element, a decoration layer, a decoration pattern, and a plurality of transmission lines. The first touch sensing element is disposed on the substrate and is positioned at least in the display region. The decoration layer is disposed on the substrate and is positioned in the non-display region, wherein the decoration layer includes at least a slot. The decoration pattern is disposed on the substrate and is at a location corresponding to the slot. The transmission lines are disposed on the substrate and are configured in the non-display region. The transmission lines are electrically connected with the second touch sensing element and cross-over the slot, wherein each transmission line includes a transparent section and a plurality of non-transparent sections connected with the two sides of the transparent section. The transparent section at least corresponds to the slot.

According to the disclosure, a slot is disposed on the decoration layer configured in the non-display region, and the decorative pattern is disposed at a location corresponding to the slot. Accordingly, in addition to a mono-color frame, the non-display region of the touch panel is provided with a frame of other color patterns. According to the invention, there is more flexibility to the exterior design of a touch panel to meet the expectations and desires of users.

### BRIEF DESCRIPTION OF THE DRAWINGS

FIG. 1 is a schematic, partial view of a touch panel according an exemplary embodiment of the disclosure.

FIG. 1A is a schematic diagram of another first sensing element of the touch panel in FIG. 1 according to an exemplary embodiment of the disclosure.

FIG. 1B is a schematic view diagram of another sensing element of the touch panel in FIG. 1 according to another embodiment of the invention.

FIG. 2 is a partial enlarged view of region A of the touch panel in FIG. 1.

FIGS. 3 and 4 are schematic, cross-sectional view diagrams, respectively, along the cutting lines II-II′ and the cutting line III-III′ of the touch panel in region A according a first exemplary embodiment of the disclosure.

FIG. 5 is a first cross-sectional view of the first touch sensing element along the cutting line A-A′ of the touch pane in FIG. 1.

FIG. 6 is a second cross-sectional view of the first touch sensing element in the touch panel in FIG. 1.

FIG. 7 is a third cross-sectional view of the first touch sensing element in the touch panel in FIG. 1.

FIG. 8 is a fourth cross-sectional view of the first touch sensing element in the touch panel in FIG. 1.

FIG. 9 is a fifth cross-sectional view of the first touch sensing element in the touch panel in FIG. 1.

FIG. 10 is a sixth cross-sectional view of the first touch sensing element in the touch panel in FIG. 1.

FIG. 11 is a seventh cross-sectional view of the first touch sensing element in the touch panel in FIG. 1.

FIG. 12 is a schematic, cross-sectional view diagram of a touch-sensing display apparatus according to an exemplary embodiment of the invention.

### DESCRIPTION OF EMBODIMENTS

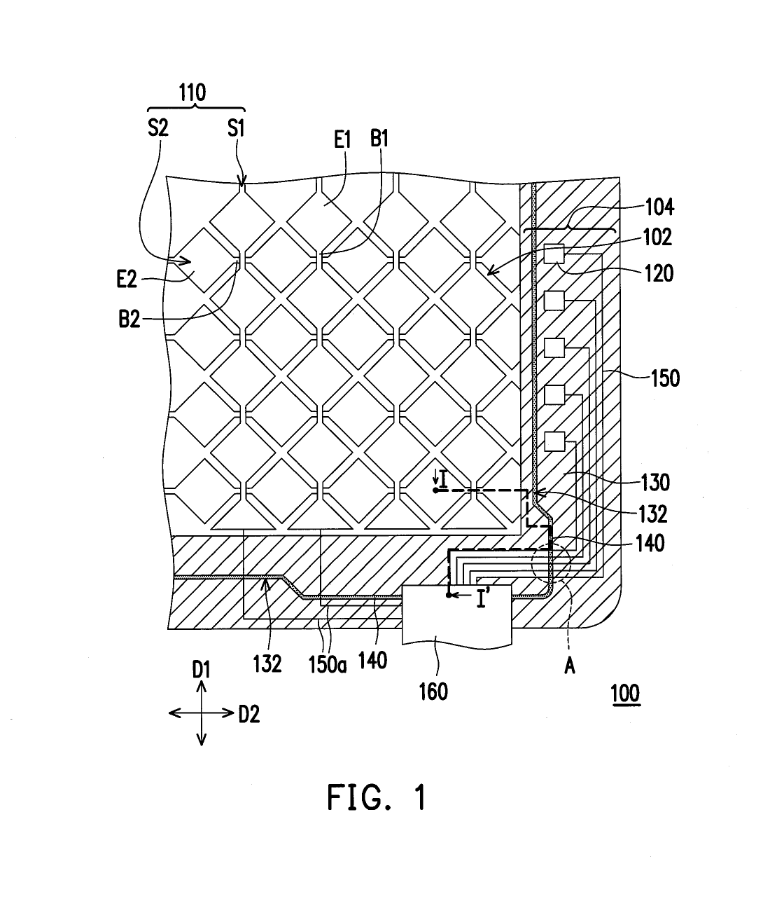

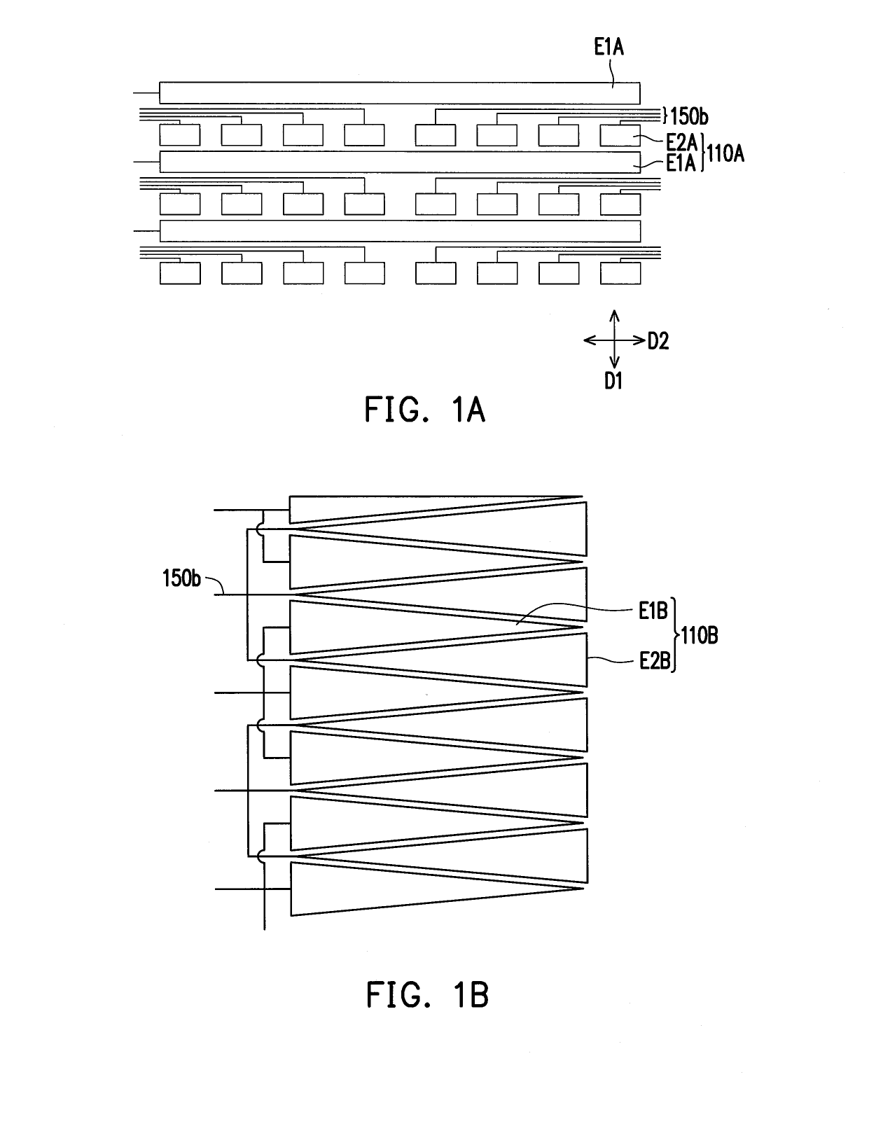

Referring to FIG. 1, a touch panel 100 includes a display region 102 and a non-display region 104 surrounding the display region 102. The touch panel 100 includes a first touch sensing element 110, a second touch sensing element 120, a decoration layer 103, a decoration pattern 140, and a plurality of transmission lines 150. In one exemplary embodiment, the touch panel 100 and the display panel are constructed together to form a touch-sensing display apparatus, wherein the touch panel 100 may serve as a cover plate of the outer components of the apparatus.

The touch sensing element 110 is configured at least in the display region 102. In the exemplary embodiment, the first touch sensing element 110 is configured in the display region 102, while the second touch sensing element 120 is configured in the non-display region 104. The decoration layer 130 is configured in the non-display region 104, and the decoration layer 130 includes at least a slot 132. The slot 132 is not limited to a particular shape and could have a ring pattern, wherein the slot 132 is configured in the non-display region 104 and encircling the display region 102, as shown in the Figure. The decoration pattern 140 at least overlaps with the slot 132. The transmission lines 150 are configured in the non-display region 104 and cross over the slot 132. The transmission lines 150 may be electrically connected with the second touch sensing element 120. Moreover, the touch panel 100 is connected with a circuit board 160. Through the circuit board 160, the first touch sensing element 110 and the second touch sensing element 120 are connected to a driver chip (not shown) for performing the touch-sensing test. In one exemplary embodiment, the driver chip (not shown) may be disposed on the circuit board or in an external circuit.

The material of the decoration layer 130 includes carbon like diamond, ceramic, photoresist, printing ink. In the current exemplary embodiment, the decoration pattern 140 and the decoration layer 130 have different colors. When a user is viewing the touch panel 100, the user may view, from the slot 132, the color difference constituted by the decoration pattern 140. Accordingly, with the touch panel 100 of the invention, different frame designs are provided to satisfy the demands of users on product appearance.

As shown in FIG. 1, the first touch sensing element 110 and the second touch sensing element 120 are respectively configured at two opposite sides of the slot 132. Additionally, the circuit board 160 is connected with the transmission lines 150 at a site, which is also in the ring pattern formed by the slot. The second touch sensing element 120 and the circuit board 160 are configured respectively at two opposite sides of the slot 132. In order for the transmission lines 150 to extend from the second touch sensing element 120 to the circuit board 160, the transmission lines 150 have to cross over the slot 132. Hence, the arrangement of the transmission lines 150 may influence the visual effect presented by the decoration pattern 140. Accordingly, a design of a touch panel is proposed to obviate the above problem as disclosed in the following exemplary embodiment.

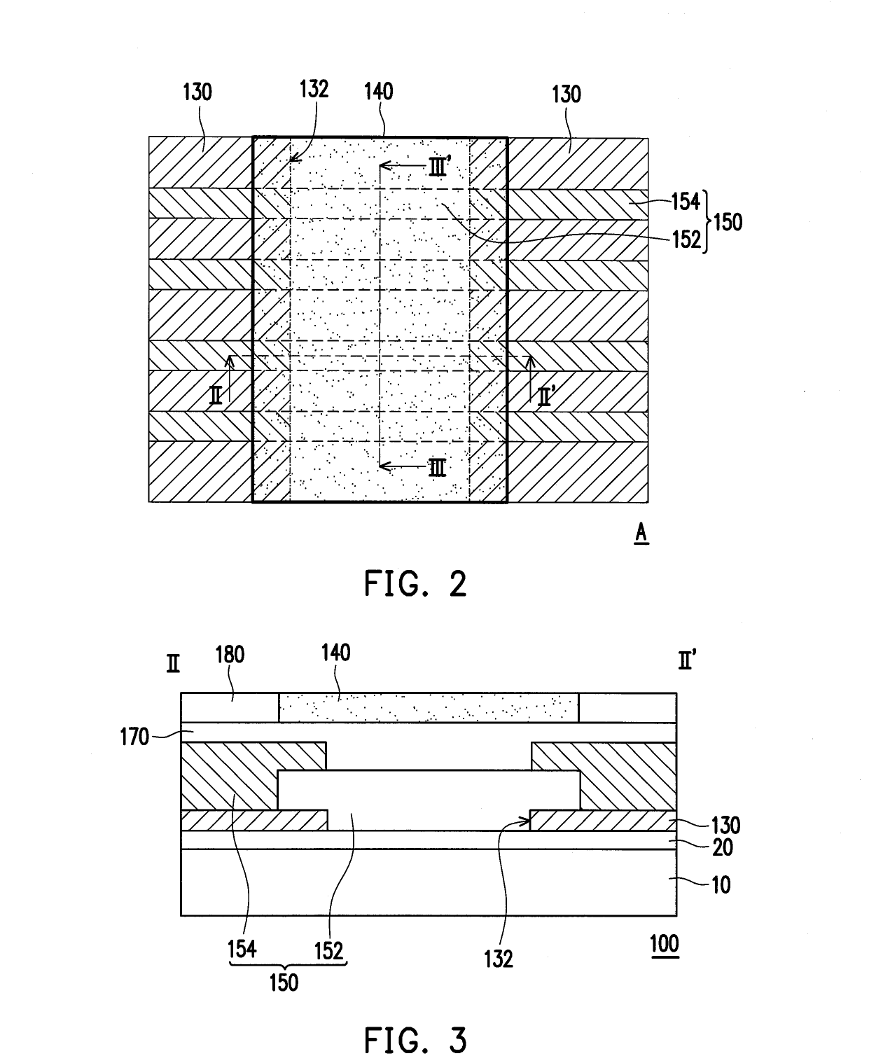

Referring to FIG. 2, in the current exemplary embodiment, each transmission line 150 includes a transparent section 152 and a plurality of non-transparent section 154, wherein the position of the transparent section 152 at least corresponds to the slot 132 of the decoration layer 130, while the non-transparent section 154 connects with the opposite sides of the transparent section 152. The material of the non-transparent section includes metal. As a whole, each transmission line 150 provides the transmission of an electrical signal, but does not affect the visual effect presented by the slot 132.

It is worthy to notice that, in the current exemplary embodiment, the transmission lines 150 that cross over the slot 132 may be a trace 150a (as indicated in FIG. 1) electrically connected with the first touch sensing element 110. It is also worthy to notice that the invention does not limit the application of the transmission lines, provided that the transmission lines are arranged on the non-display region 104 and cross over the slot 132 and the decoration pattern 140.

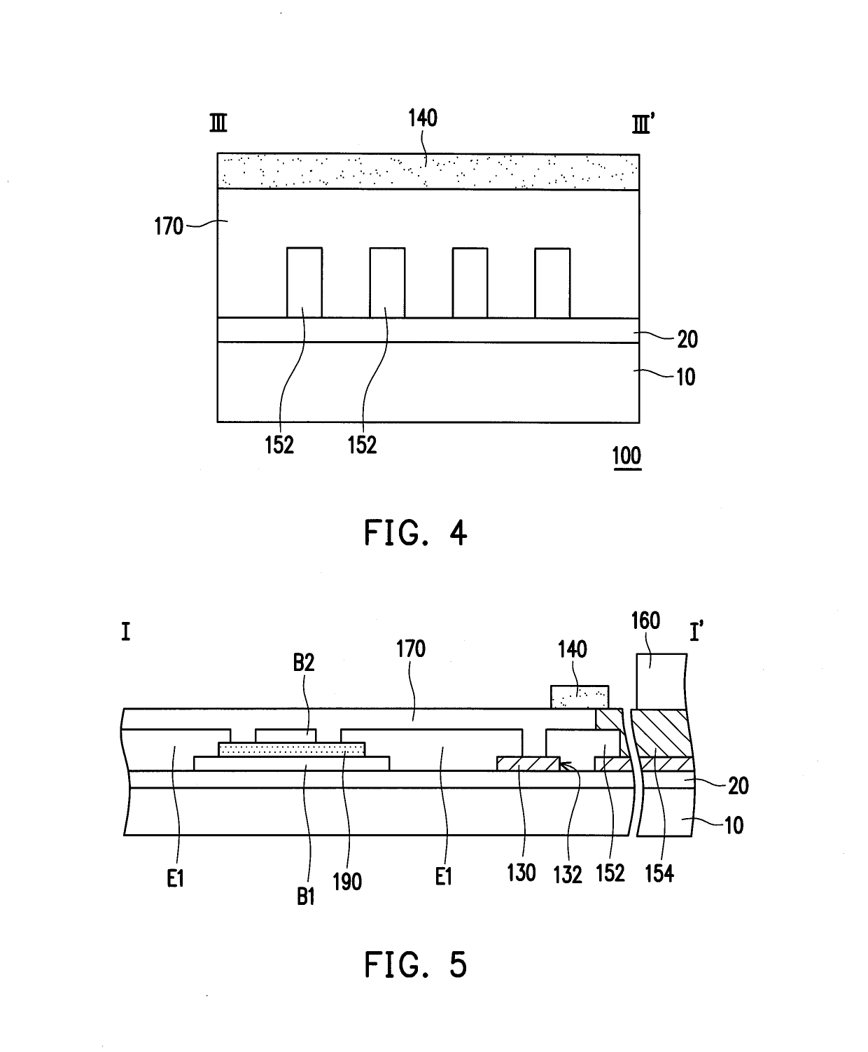

Referring to FIGS. 2 to 4, a bottom insulation layer 20 may be optionally disposed on the substrate 10 of the touch panel 100, and other components are configured on the bottom insulation layer 20. The touch panel 100 further includes a passivation layer 170 covering the first touch sensing element 110, the second touch sensing element 120, the decoration layer 130, and the transmission lines 150, and the decoration pattern 140 is disposed on a side of the passivation layer 170 that is different from the side of the passivation layer 170 on which the decoration layer 130 is disposed.

The invention does not limit the design of the passivation layer 170 with only the decoration pattern 140 disposed thereon. The touch panel 100 further includes disposing a shielding layer 180 on the side of the decoration pattern 140 or covering the decoration pattern 140 entirely. The shielding layer 180 may be disposed in the non-display region 140 as shown in FIG. 1, wherein the shielding layer 180 and the decoration pattern 130 are disposed on a same plane on a part of the passivation layer 170. Alternatively, the shielding layer 180 and the decoration pattern 130 are not configured on a same plane, and the shielding layer 180 covers the decoration pattern 130 and a part of the passivation layer 170. Due to the configuration of the shielding layer 180, the shielding effect on the non-display region 104 is further enhanced.

The design of the first touch sensing element 110 according to an exemplary embodiment is disclosed herein below. Referring concurrently to FIGS. 1 and 5, the first touch sensing element 110 of the touch panel 100 includes a plurality of first sensing series S1 and a plurality of second sensing series S2, wherein the first extension direction of each first sensing series S1 intersects with the second extension direction D2 of each second sensing series S2, and the first sensing series S1 are electrically independent from the second sensing series S2. The first sensing series S1 and the second sensing series S2 may be disposed on one side or two sides of the substrate 10. The shapes of the first sensing series S1 and the second sensing series S2 are not limited.

Alternatively speaking, the first sensing series S1 include a plurality of first sensing pads E1 and a plurality first bridge lines B1 serially connecting the first sensing pads E1 along the first direction D1. The second sensing series S2 includes a plurality of second sensing pads E2 and a plurality of second bridge lines B2 serially connecting the second sensing pads E2 along the second direction D2. The first bridge lines B1 are disposed on the bottom insulation layer 20. The first bridge lines B1 connect with the two ends of the first sensing pads E1, while the second bridge lines B2 are disposed above the first bridge lines B1. The first bridge lines B1 and the second bridge lines B2 are separated by an insulation structure 190. The insulation structure 190 is, for example, an island-shaped insulation pattern. The plurality of first sensing pads E1 and the plurality of second sensing pads E2 are not limited to any geometric configuration, and they can have the shape of rhombus, triangle, straight line, etc. Similarly, the first sensing series S1 and the second sensing series S2 may have the shape of rhombus, triangle, straight line, or other geometric configuration. Moreover, the cross-sectional structure of the first touch sensing element 110 is not limited to the one as depicted in FIG. 5. The first touch sensing element 110 with a different cross-sectional structure is exemplified in the following embodiments. Although the disclosure of the design of the first touch sensing element 110 refers to a certain illustrated embodiments, it is to be understood that these embodiments are presented by way of example and not by way of limitation. Different designs of the first touch sensing element 110 can also be implemented in accordance with the present invention. For example, FIG. 1A is a schematic diagram of another first sensing element 110A of the touch panel in FIG. 1 according to an exemplary embodiment of the invention. As shown in FIG. 1 A, the first touch sensing element 110A is constructed from a single conductive layer, and includes a single layer of a plurality of first sensing pads E1A and a plurality of second sensing pads E2A. In this exemplary embodiment, the first sensing pads E1A and the second sensing pads E2A are alternately arranged in the first direction D1. Further, the extension direction of each first sensing pad E1A is parallel to the second direction D2. The plurality of second sensing pads E2A is located between two adjacent first sensing pads E1A. Moreover, each of the sensing pads E1A and E2A is connected to a trace 150b, which can be extended to the non-display region 104 and crosses over the slot 132. FIG. 1B is schematic view of another sensing element 110B comprising the sensing pads E1B and E2B according to another embodiment of the invention. As shown in FIG. 1B, the first touch sensing element 110B is a single layer of sensing pads, which includes triangular first sensing pads E1B and triangular second sensing pads E2B. Moreover, each of the first and second sensing pads E1B and E2B is connected to a trace 150b, which can be extended to the non-display region 104 and crosses over the slot 132. It is noted that, in addition to the shape of a triangle or a rectangle as depicted in FIGS. 1A and 1B, the sensing pads E1A, E2A, E1B, and E2B can be configured in other shapes and can be formed by the same conductive layer or different conductive layers.

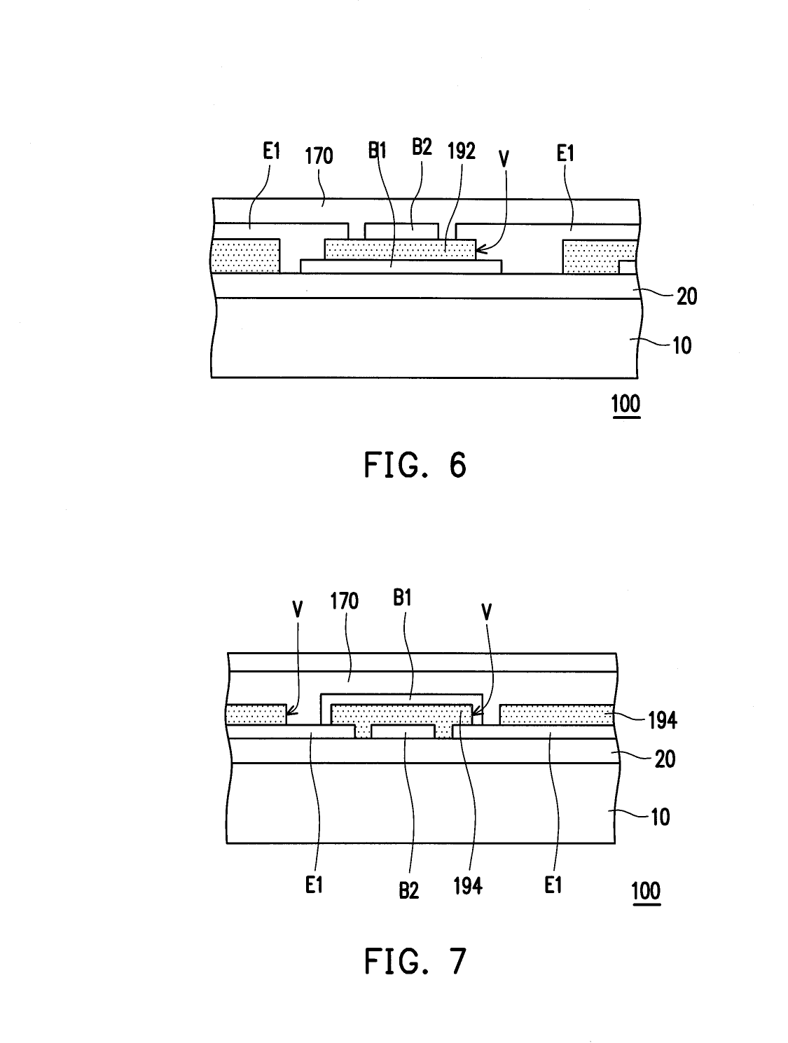

Referring concurrently to FIGS. 6 and 1, the cross-sectional structure of the touch sensing element 110 in this exemplary embodiment is similar to that depicted in FIG. 5. The main difference between the two touch sensing elements is that the insulation structure 192 has a layered shape structure, rather than an island-shaped insulation pattern. The layered shape insulation structure 192 includes a plurality of contact vias V for the first sensing pads E1 to electrically connect with the first bridge lines B1.

Referring concurrently to FIGS. 7 and 1, due to a different fabrication sequence of each device, the cross-sectional structure of the first touch sensing element 110 varies. In the first touch sensing element 110, the second sensing pads E2 of the second touch sensing series S2 and the second bridge lines B2, the first sensing pads E1 of the first touch sensing series S1 are fabricated from a same film layer. Hence, the first touch sensing pad E1 and the second touch sensing pad E2 are disposed on a same plane on the cover plate 110.

Moreover, the touch panel 100 includes the layered shape insulation structure 194, covering the first sensing pads E1 and the second sensing series S2, which are formed with the same film layer. The insulation structure 194 includes a plurality of contact vias V, which exposes the first sensing pads E1.

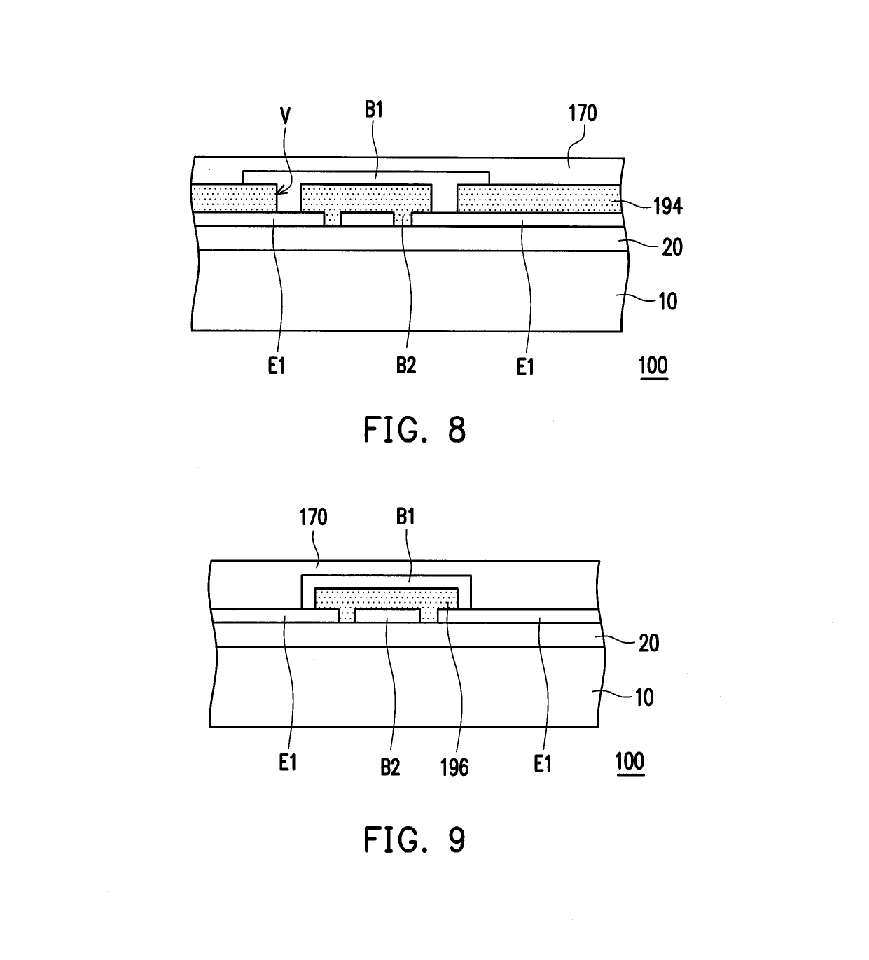

Referring concurrently to FIGS. 8 and 1, the design approach of the first touch sensing element 110 in this exemplary embodiment is similar to that depicted in FIG. 7. The main difference between the two touch sensing elements is that the first bridge lines B1 in this exemplary embodiment is fabricated with a transparent conductive material. The fabrication method of the first bridge lines B1 in this exemplary embodiment includes depositing a transparent conductive layer on the insulation structure 194, and forming the first bridge lines B1 by patterning the transparent conductive layer through photolithograph and etching Accordingly, the first bridge lines B1 fill the contact vias V of the insulation structure 194.

Referring concurrently to FIGS. 9 and 1, the design of the touch sensing element 110 in this exemplary embodiment is similar to that depicted in FIG. 8. The difference between the two designs lies in the insulation structure 196, wherein the insulation structure 196 of the current exemplary embodiment has an island-shape insulating pattern. Further, the insulation structure 196 is partially located between the first bridge lines B1 and the second bridge lines B2.

Referring to FIG. 10, the first sensing series S1 and the second sensing series S2 are fabricated with different film layers on different planes, resulting with these two sensing series of different film layers being separated by an insulation layer 198.

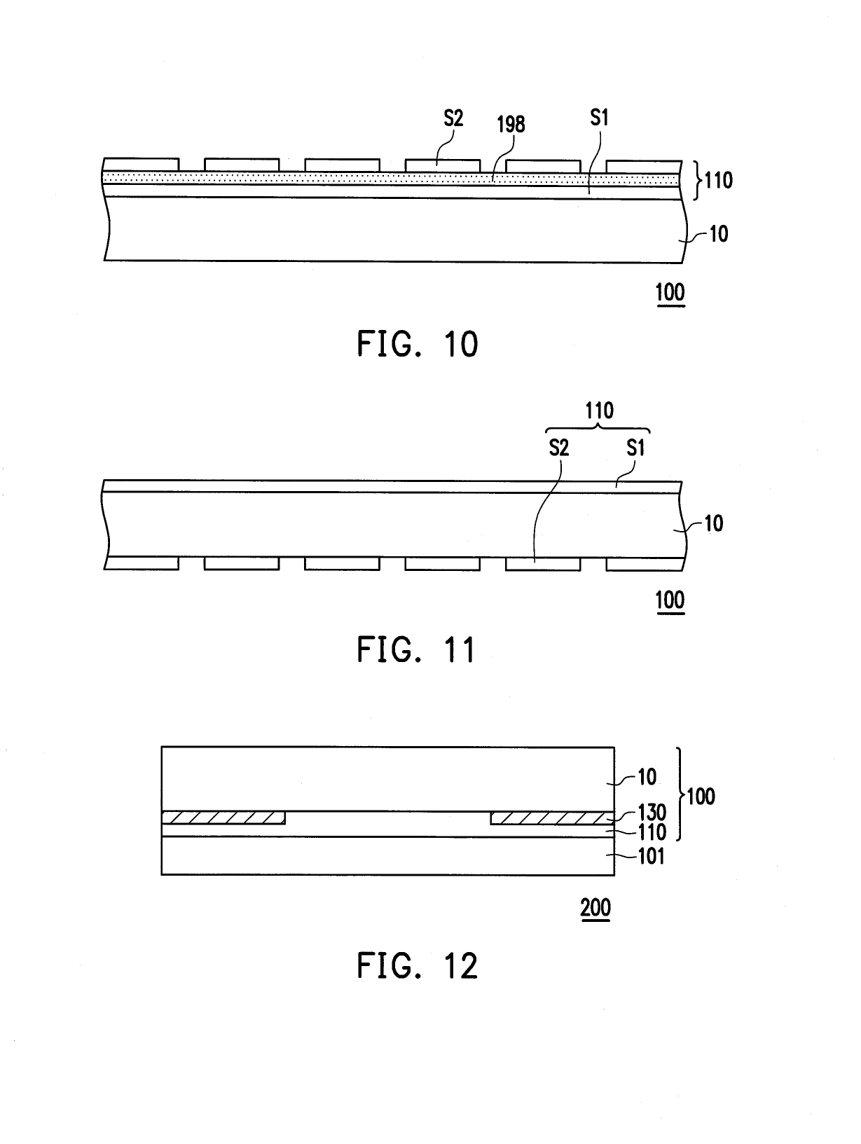

Referring to FIG. 11, in the first touch sensing element 110 is disposed on the substrate 10, the first sensing series S1 and the second sensing series S2 respectively configured on two corresponding sides of the substrate 10. Here, the insulation layer 198, as shown in FIG. 10, is not required.

Additionally, the above touch panel may combine with a display panel to form a touch-sensing display apparatus. As shown in FIG. 12, the touch panel 100 is assembled on a display panel 101, for example, with an optical adhesive, wherein the touch panel 100 may be any one of touch panels in the above exemplary embodiments. The type of display panel 101 is not limited in the invention, and the display panel 101 may be a liquid crystal display device, an organic light emitting display device, an electrowetting display device, or an electrophoretic display device.

According to the exemplary embodiments of the invention, a slot is disposed in the decoration layer of the touch panel and a color decorative pattern is also disposed at a location corresponding to the slot. As a result, the touch panel does not have a mono-color black frame. Instead, the frame has a colorful pattern. Moreover, the transmission lines that cross over the slot are formed with transparent conductive materials. Hence, the visual effect presented by the slot is not affected by the presence of the transmission lines.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising a display region and a non-display region surrounding the display region, the touch panel comprising:
a substrate;
a touch sensing element, disposed on the substrate and at least in the display region;
a decoration layer, disposed on the substrate and in the non-display region, the decoration layer comprising at least one slot;
a decoration pattern, disposed on the substrate and at a location corresponding to the at least one slot; and
a plurality of transmission lines, disposed on the substrate in the non-display region, and the plurality of transmission lines crosses over the at least one slot, wherein each of the transmission lines comprises a transparent section and a plurality of non-transparent sections connecting with two sides of the transparent section, and the transparent section is configured at a location at least corresponding to the at least one slot.

2. The touch panel of claim 1, wherein the at least one slot is configured in the non-display region encircling display region.

3. The touch panel of claim 1 further comprising a second touch sensing element, wherein the second touch sensing element is disposed on the substrate in the non-display region, wherein the plurality of transmission lines is connected with the second touch sensing element.

4. The touch panel of claim 1, wherein the plurality of transmission lines is electrically connected with the first touch sensing element.

5. The touch panel of claim 1, wherein the decoration pattern and the decoration layer comprise different colors.

6. The touch panel of claim 3 further comprising a circuit board, disposed on the substrate and in the non-display region, and the plurality of transmission lines extending from the second touch sensing element to the circuit board for the second touch sensing element to electrically connect with the circuit board.

7. The touch panel of claim 1, wherein the transparent section of the each of the transmission lines is positioned between the decoration pattern and the substrate.

8. The touch panel of claim 1 further comprising a shielding layer, disposed on the substrate and in the non-display region, the shielding layer and the decoration pattern being on a same plane.

9. The touch panel of claim 1, wherein the shielding layer covers the decoration pattern.

10. The touch panel of claim 1, wherein the first touch sensing element comprises a plurality of first touch sensing series and a plurality of second touch sensing series, a first extension direction of each of the first touch sensing series intersects with a second extension direction of each of the second touch sensing series, and the plurality of first touch sensing series is electrically independent from the plurality of second touch sensing series.

11. The touch panel of claim 1, wherein the first touch sensing element comprises a single layer of sensing pads, which include a plurality of first sensing pads and a plurality of second sensing pad, and the plurality of first sensing pads and the plurality of second sensing pads are alternately arranged, and each of the first sensing pads and each of the second sensing pads are respectively connected to one of the plurality of transmission lines.

12. A touch-sensing display apparatus, comprising:
a touch panel that comprises a display region and a non-display region encircling the display region;
a substrate;
a first touch sensing element, disposed on the substrate and at least in the display region;
a decoration layer, disposed on the substrate and in the non-display region, and the decoration layer comprising at least a slot;
a plurality of decoration patterns, disposed on the substrate and at a location corresponding to the slot;
a plurality of transmission lines, disposed on the substrate in the non-display region, the plurality of transmission lines crossing over the at least slot, wherein each of the transmission lines comprises a transparent section and a plurality of non-transparent sections connecting with two sides of the transparent sections, and the transparent section is at a location corresponding to the at least slot; and
a display panel, assembled with the touch panel.
